(19) United States
(12) Patent Application Publication
(10) Pub. No.: US 2006/0011663 A1
(43) Pub. Date: Jan. 19, 2006

(54) Metering apparatus for media

(76) Inventor: Juergen Greiner-Perth, Gottmadingen (DE)

Correspondence Address: FLYNN THIEL BOUTELL & TANIS, P.C., 2026 RAMBLING ROAD, KALAMAZOO, MI, 49008-1631, US

(21) Appl. No.: 11/180,196

(22) Filed: Jul. 13, 2005

(30) Foreign Application Priority Data
Jul. 13, 2004 (DE) 102004035141.4
Feb. 22, 2005 (DE) 102005009295.0

(51) Int. Cl. B67D 5/40

(52) U.S. Cl. 222/383.1

(57) ABSTRACT

A metering apparatus for media includes an applicator with a metering opening, having a pump device having pump parts which can move in the axial direction relative to one another in order to deliver medium out of a medium reservoir to the metering opening, metering chamber with an outlet valve, having a manually operable actuating device, which is operatively connected to the pump device in order to achieve a pump stroke, and spring accumulator, which can be pre-stressed by movement of the actuating device and can be released by a triggering unit as a function of an actuating stroke of the actuating device in order to enable a metering stroke of the pump device to be carried out. The pump device comprises a buffer chamber which, in the event of an actuating stroke, receives a metered volume from the metering chamber and out of which the metered volume is discharged to the metering opening during a metering stroke.

### FIELD OF THE INVENTION

The invention relates to a metering apparatus for media having an applicator, which has at least one metering opening, having a pump device, which has pump parts which can move in the axial direction relative to one another in order to deliver medium out of a medium reservoir to the metering opening, having a metering chamber, having an inlet valve, having a manually operable actuating device, which is operatively connected to the pump device in order to achieve a pump stroke, and having a spring accumulator, which can be pre-stressed by movement of the actuating device and can be released by a triggering unit as a function of an actuating stroke of the actuating device in order to enable a metering stroke of the pump device to be carried out.

### BACKGROUND OF THE INVENTION

A metering apparatus of this type is known from DE 102 20 557 A1. The known metering apparatus results in a user-independent function, on account of the fact that the discharging of medium is not dependent on the actuating force of the operator, but rather only on the spring force of the spring accumulator. The actuating stroke brought about by the operator serves only to pre-tension the spring accumulator. The triggering unit, in particular after the active actuating stroke has ended, releases the spring accumulator, so that the latter can effect the metering stroke of the pump device for discharging the medium from the metering opening. The pump device including the corresponding pump parts and the spring accumulator as well as a restoring spring arrangement are accommodated in a housing section of the metering apparatus which projects into the medium reservoir.

### SUMMARY OF THE INVENTION

It is an object of the invention to provide a metering apparatus of the type described in the introduction which allows a compact and, in terms of its length with respect to the pump axis, relatively short configuration.

This object is achieved by virtue of the fact that the pump device comprises a buffer chamber which, in the event of an actuating stroke, receives a metered volume from the metering chamber and out of which the metered volume is discharged to the metering opening during a metering stroke. It is preferable for the buffer chamber to have just one chamber opening, which forms both an inlet opening and an outlet opening for the metered volume. Therefore, during an actuating stroke, the metered volume is conveyed out of the metering chamber and initially into the buffer chamber. During a subsequent metering stroke, the medium, as a result of a corresponding reversal of the direction of flow, is delivered back out of the chamber opening of the buffer chamber and discharged via the metering opening. The solution according to the invention is suitable in particular for metering apparatuses which are used for pharmaceutical or cosmetic purposes. The metering apparatus according to the invention is used in particular to discharge liquid or free-flowing media, such as gels, foams, suspensions and the like. The metering apparatus is preferably suitable for nasal applications. Other embodiments are provided for other forms of applications.

In one configuration of the invention, the volume of the buffer chamber can be changed by a metering piston, to which the spring accumulator is operatively connected. The metering piston is used to discharge the metered volume of medium in the direction of the metering opening.

In a further configuration of the invention, the metering chamber is configured as an annular chamber of variable volume which coaxially surrounds the buffer chamber. This represents a particularly space-saving variant.

The object on which the invention is based is also achieved by virtue of the fact that the spring accumulator is arranged axially between the metering opening and a medium reservoir. This allows the metering apparatus to be fitted on to the medium reservoir, yet nevertheless to achieve user-independent metering.

The object on which the invention is based is also achieved, for the metering apparatus of the type described in the introduction in which the actuating device and/or the pump device is assigned a restoring spring arrangement for returning the pump parts into a starting position, by virtue of the fact that the spring accumulator and the restoring spring arrangement, at least in sections, are arranged such that they are fitted coaxially over one another. The arrangement whereby the spring accumulator and restoring spring arrangement are mounted coaxially over one another allows the metering apparatus to be of relatively short configuration without adversely affecting the corresponding spring functions.

In a further configuration of the invention, a housing part of the metering apparatus which can be connected to the medium reservoir is assigned a venting device for the medium reservoir. This allows a constant atmospheric pressure to prevail in the medium reservoir.

In a further configuration of the invention, the spring accumulator and the restoring spring arrangement are formed by a common coil spring. The spring characteristic of the coil spring is matched to the different spring functions in such a manner that it can perform both the function of the spring accumulator and the function of the restoring spring arrangement. Moreover, the coil spring is also supported on the corresponding pump components of the pump device in a suitable way to allow the desired functions to be achieved.

In a further configuration of the invention, the common coil spring also comprises a spring function for closing an outlet valve in the region of the metering opening. As a result, the coil spring performs a further spring function, and its spring characteristic and design are correspondingly adapted to this triple function.

In a further configuration of the invention, all the spring elements, including spring accumulator, restoring spring arrangement and closing spring for the outlet valve, are arranged outside the flow path of the medium. This is advantageous in particular if the spring elements consist of metal. This rules out the possibility of the properties of the medium being adversely affected by the spring elements.

According to the invention, in a metering apparatus for media having an applicator for discharging medium, having a pump device, which has pump parts which can move axially relative to one another in order to deliver medium out of a medium reservoir to a metering opening of the applicator, and having a venting device assigned to the medium reservoir, it is provided that the venting device is configured as a venting valve in the form of an annular lip seal, which annularly surrounds the outer side of a suction connection piece projecting into the medium reservoir. The result is a desired pressure balancing in the medium reservoir during corresponding actuating or metering strokes on the part of the metering apparatus. An additional result is an improved water vapor barrier in the presence of a filter, in order to reduce the passage rate at the filter.

In a further configuration of the invention, the suction connection piece has an annular shoulder which forms a valve seat, and the annular lip seal has a sealing collar, which protrudes radially with respect to the pump axis and on the inner side comprises a conically tapered sealing surface. This results in a venting valve which is of particularly simple configuration yet is nevertheless operationally reliable. It is preferable for the venting valve in the form of the annular lip seal to form an integral part of a sealing ring between the metering apparatus and the medium reservoir.

In a further configuration of the invention, the annular shoulder forms a right-angled step shoulder, against the peripheral edge of which the conically tapered sealing surface bears at an acute angle. This creates virtually linear contact between the step shoulder serving as a valve seat and the sealing surface serving as a valve plate.

The object on which the invention is based is also achieved, for the metering apparatus of the type described in the introduction, by virtue of the fact that the triggering unit is designed as an outlet valve which is provided for temporarily closing a medium passage, which is assigned to the metering chamber and is connected to the metering opening, at the pump device. The outlet valve is therefore based on the object of releasing the actuation energy contained in the pre-stressed spring accumulator when a pre-determinable energy level is reached and at the same time allowing the pressurized medium in the metering chamber to flow out into the medium passage in the direction of the metering opening. This synchronization function allows the triggering unit, which is configured as an outlet valve, to discharge medium from the metering chamber accurately in a pre-determined design position of the pump device, thereby ensuring that demands imposed with regard to spraying strength and/or atomization of the discharged medium can be accurately achieved. The medium passage, which is at least temporarily closed by the outlet valve, can open out directly into the metering opening or may be temporarily closed by a metering valve which, in addition to the outlet valve, allows control of the medium to be discharged and thereby makes a contribution to an advantageous discharge operation.

In a further configuration of the invention, the outlet valve is formed from a metering pin assigned to the metering chamber and a pump plunger which can move relative to the metering pin. Consequently, a medium passage which is provided in the pump plunger and is connected to the metering opening can be closed until a medium pressure, which is dependent on an actuation travel and the spring force of the spring accumulator of the pump device, in the metering chamber is reached. The metering pin can be arranged in the metering chamber and operatively connected to the pump plunger in such a manner that it likewise allows the spring accumulator to be released as a function of travel. This can be achieved by a metering edge of the metering pin being designed in such a way that a flow of medium through the medium passage is only permitted when a minimum actuation travel has been exceeded.

In a further configuration of the invention, a venting device is provided, which comprises a venting valve in the form of an annular lip seal, which annularly surrounds the outer side of a suction connection piece projecting into the medium reservoir. This results in a desired pressure compensation for the medium reservoir in the event of corresponding actuating or metering strokes on the part of the metering apparatus. An additional result is an improved water vapor barrier in the presence of a filter, in order to reduce the passage rate at the filter.

In a further configuration of the invention, the outlet valve has a valve body and a spring device which is assigned to the valve body and is designed to apply a valve-closing force. The valve body, which may in particular be of conical or spherical configuration at least in portions, together with a valve seat assigned to the pump device, forms a closable valve gap. In an open position, the valve gap allows the medium to flow out into the medium passage. To prevent the medium from being able to flow out even at a low pressure difference between metering chamber and medium passage, the valve body is assigned a spring device which presses the valve body into a closed position with the valve seat. Consequently, displacement of the valve body into the open position and opening of the valve gap are only permitted when a pre-determinable pressure level in the metering chamber is exceeded. The design configuration of the outlet valve ensures a minimum pressure level for the medium to flow out of the metering chamber. This also results in a pre-determinable pressure level for the medium between medium passage and environment at the metering opening, so that the medium can be discharged, in particular sprayed out, in the desired way.

In a further configuration of the invention, the spring device is designed as a compression spring. This makes it possible to ensure an advantageous and compact design of the pump device and the associated valve device with the valve body and the spring device. In a preferred embodiment, the spring device is designed as a plastic compression spring, which may be produced in particular as a plastic injection-molded part at favorable production costs. On account of the inert properties of the plastic material used, the plastic compression spring can also be arranged without problems in the medium passage without having any adverse affects on the medium which is to be discharged, for example corrosion phenomena. In a particularly preferred embodiment, the spring device is configured as a plastic compression spring formed integrally with the valve body. This allows a particularly advantageous configuration to be selected for the valve body and the spring device, since these components can be matched to one another in a favorable way. Furthermore, a single-piece configuration also allows advantageous assembly of the valve body with the spring device at the outlet valve.

In a further configuration of the invention, at the end side the medium passage opens out from a pump plunger assigned to the pump device into the metering chamber, and the valve body is accommodated in the pump plunger for the purpose of closing the end-side opening of the medium passage. This type of arrangement of the medium passage in the pump plunger makes it possible to ensure a particularly slender design of the pump device, since the pump plunger is intended for sliding-contact bearing of a sealing collar, and therefore in any case has in particular a cylindrical contour. The medium passage and the outlet valve can be arranged in the slender contour of the pump plunger without taking up additional space. Arranging the opening of the medium passage in the pump plunger at an end-side allows particularly advantageous flow of the medium which is being pressurized in the metering chamber by the pump plunger or the associated sealing collar into the medium passage to be ensured. Furthermore, arranging the opening of the medium passage at the end side of the pump plunger allows the outlet valve to be oriented in the direction of a longitudinal center axis of the pump plunger, which also corresponds to a direction of movement of the pump plunger in the metering chamber in order to compress the medium.

In a further configuration of the invention, the valve body has a projection which, in an at-rest position of the outlet valve, projects beyond an end-side of the pump plunger facing the metering chamber into the metering chamber and is provided for operative connection to a wall section, lying opposite the end-side of the pump plunger, of the metering chamber. This makes it easy to realize a travel-controlled actuation of the outlet valve and therefore release of the spring device. The pump plunger, which during the pumping operation is moved in the direction of its longitudinal center axis in the metering chamber, during this movement approaches an opposite wall section of the metering chamber. The projection which is provided on the valve body of the outlet valve can therefore come into contact with the wall section of the metering chamber during this approach and, in the event of further movement of the pump plunger, allows the valve body to be displaced out of the valve seat. As a result, the valve gap is opened, and the pressurized medium which has flowed into the metering chamber can flow out into the medium passage through this valve gap. Since the outlet valve, as a result of the contact with the wall section of the metering chamber, is actuated directly by the operating force which the user exerts on the pump device, the spring device of the outlet valve can be designed in such a way that the outlet valve does not open just as a result of the pressurized medium in the metering chamber. Rather, reliable closure of the medium passage is ensured by the outlet valve until the projection comes into contact with the wall section of the metering chamber.

In a further configuration of the invention, an inlet valve assigned to the metering chamber is designed as a diaphragm valve for closing a medium passage connected to the medium reservoir. A diaphragm valve, which may be designed in particular as a planar sealing plate of flexible or rigid material, allows a particularly compact inlet valve which is simple to produce to be realized. A diaphragm valve of this type ensures reliable closure of the metering chamber in the direction of a medium passage connected to the medium reservoir. Moreover, the diaphragm valve allows a substantially planar configuration of a wall section lying opposite the pump plunger, so that the function of the outlet valve with respect to the operative connection between valve body and wall section can be ensured.

### BRIEF DESCRIPTION OF THE DRAWINGS

Further advantages and features of the invention will emerge from the claims and from the following description of preferred exemplary embodiments of the invention, which are illustrated with reference to the drawings, in which:

FIG. 1 shows a sectional illustration through a first embodiment of a metering apparatus according to the invention in the load-free starting position,

FIG. 2 shows the metering apparatus illustrated in FIG. 1 shortly before an actuating stroke has ended,

FIG. 3 shows the metering apparatus illustrated in FIGS. 1 and 2 after a discharge operation has ended,

FIG. 4 shows a sectional illustration through a further embodiment of a metering apparatus according to the invention in the load-free starting position,

FIG. 5 shows the metering apparatus illustrated in FIG. 4 shortly before the discharge operation commences,

FIG. 6 shows the metering apparatus illustrated in FIGS. 4 and 5 after the discharge operation has ended,

FIG. 7 shows the metering apparatus illustrated in FIGS. 4 to 6 with closure cap and actuation block,

FIG. 8 shows a metering apparatus similar to that shown in FIG. 7, but with a modified venting valve for a medium reservoir,

FIG. 9 shows a further embodiment of a metering apparatus according to the invention in the load-free starting position,

FIG. 10 shows the metering apparatus illustrated in FIG. 9 shortly before a discharge operation, and

FIG. 11 shows the metering apparatus illustrated in FIGS. 9 and 10 after the discharge operation has ended,

FIG. 12 shows a further embodiment of a metering apparatus according to the invention with a spring-preloaded triggering valve in the load-free starting position,

FIG. 13 shows the metering apparatus illustrated in FIG. 12 shortly before a discharge operation, and

FIG. 14 shows the metering apparatus illustrated in FIGS. 12 and 13 after the discharge operation has ended,

FIG. 15 shows a modified embodiment of the metering apparatus illustrated in FIGS. 12 to 14 with an annular lip seal.

### DETAILED DESCRIPTION OF THE INVENTION

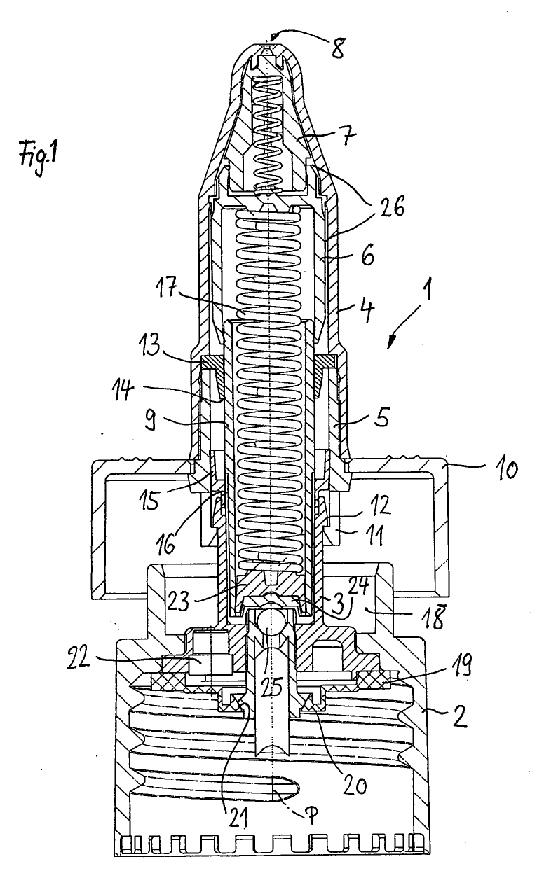

The embodiment illustrated in FIGS. 1 to 3 shows a metering apparatus 1 which can be screwed onto a medium reservoir (not shown) by means of a closure part 2. The closure part 2 is designed in the form of a cap and coaxially surrounds a base region 3 of the metering apparatus 1, the base region 3 of the metering apparatus 1 extending upward along a pump axis P. The base region 3 is of sleeve-like design and has a lower annular shoulder, which bears a venting filter 22 and is held in a positively locking manner between a supporting shoulder of the closure part 2 and a sealing ring 19 in the position in which the closure part 2 has been screwed onto the medium reservoir. The venting filter 22 is designed as a germ filter to allow sterile venting of the medium reservoir. The gaseous medium which flows into the medium reservoir through the venting filter 22 for pressure compensation purposes after medium has been discharged is thus sterile-filtered.

A nasal applicator 4 serves as a housing for a pump device, which is described in more detail below, and is dome-like in form. At the upper end of the nasal applicator 4 there is a metering opening 8, which in the exemplary embodiment illustrated is designed as a spray nozzle. The nasal applicator 4 is fixedly connected, by combined positive and nonpositive locking—in the present case by press-fitting in combination with an annular latching profile—to an intermediate sleeve 5 which, with the aid of guide webs 11, is guided with limited linear mobility on the base region 3, coaxially with respect to the pump axis P. The guide webs 11 have latching lugs which interact with corresponding stop regions of the base region 3. An upper stop region is formed by an annular shoulder 12, and a lower stop region is formed by an encircling protuberance, which projects in the radial direction but is not indicated in more detail.

A finger support 10, which can move in the axial direction together with the intermediate sleeve 5 and the nasal applicator 4, is fixed to the intermediate sleeve 5.

A cylinder sleeve 9, which is held preferably likewise nonpositively by press-fitting in the sleeve-like section of the base region 3, is arranged in a fixed position coaxially inside the base region 3. The cylinder sleeve 9 projects upward beyond the base region 3 and into the nasal applicator 4. A metering piston 23, which in the manner of a sealing collar is supported, in a circumferentially sealed manner, against the inner wall of the cylinder sleeve 9, is guided in a longitudinally displaceable manner in the cylinder sleeve 9. The metering piston 23 is subjected to compressive force in the direction of the closure part 2, and therefore in the downward direction in accordance with the embodiment illustrated, by a spring accumulator 17. In the embodiment illustrated, the spring accumulator 17 is designed as a coil spring which on one side is supported against the metering piston 23 and on the other side is supported against a guide part 6, arranged in a fixed position in the nasal applicator 4. The spring accumulator 17 additionally also serves as a restoring spring for returning the nasal applicator and the finger support into an upper starting position after a pump stroke has taken place. The fixed arrangement is effected by the guide part 6 latching in the nasal applicator 4 in accordance with the latching profiles which can be seen with reference to FIGS. 1 to 3.

In a lower region, the base region 3 has a suction connection piece, which is not indicated in more detail and which—if appropriate with the aid of a flexible suction tube fitted in from below—forms a suction passage for the pump device, in order for medium to be delivered from the medium reservoir into the pump device. The suction passage can be closed off in an upper end region of the suction connection piece by a non-return valve which, in the embodiment illustrated, is designed as a ball valve 25. Other types of non-return valves are provided in exemplary embodiments which are not illustrated. The ball valve 25 is assigned a securing cage 24, which is formed integrally at a lower end region of the cylinder sleeve 9. The securing cage 24 is designed in such a way that it allows the ball valve 25 to open but at the same time holds the ball valve 25 captively.

In its lower end region, the guide part 6 forms a sealing casing which tightly surrounds an outer lateral surface of the cylinder sleeve 9. At the top, the guide part 6 forms a further annular casing which tightly surrounds a cylinder section of an outlet valve 7. The outlet valve 7 is guided axially movably in the guide part 6 by means of the annular casing and serves to open and close the metering opening 8, in the present instance the spray nozzle. The outlet valve 7 is spring-loaded in the closing direction by a restoring spring (not shown in more detail), which is designed as a coil spring. The restoring spring is arranged inside the outlet valve 7 and therefore does not come into contact with the medium. Further details can be found in the drawings.

A metering chamber, which is delimited at the top in the axial direction by a sealing collar 13, is formed in the style of an annular space between an outer cylinder wall of the cylinder sleeve 9 and a cylindrical inner wall of the intermediate sleeve 5. The sealing collar 13 is fixed in a positively locking manner between a step shoulder of the nasal applicator 4 and an upper end edge of the intermediate sleeve 5 and is in sealing contact with the outer cylinder wall of the cylinder sleeve 9. At its lower edge region, the sealing collar 13 has an encircling sealing lip 14 which produces the sealing action with the cylinder sleeve 9. The sealing lip 14 is of elastically resilient design. Moreover, an inner lateral surface of the sealing collar 13 is designed with a slightly larger diameter than the external diameter of the cylinder wall of the cylinder sleeve 9, so that in the event of elastic yielding of the sealing lip 14 in the radial direction, a narrow, medium-carrying annular gap can be formed between sealing collar 13 and cylinder sleeve 9.

The metering chamber is delimited at the bottom by a further sealing collar 15, which is arranged in a fixed position—in the present case by nonpositive clamping—between an upper annular shoulder of the base region 3 directly above the stop shoulder 12 and the cylinder sleeve 9.

Starting from a lower end edge of the cylinder sleeve 9, a plurality of axially running longitudinal grooves 16 are provided in the outer cylindrical wall of the cylinder sleeve 9, which longitudinal grooves begin at a lower end edge and extend upward as far as into the outwardly protruding part of the lower sealing collar 15. These longitudinal grooves 16 form flow paths from the inlet connection piece and the ball valve 25 to the metering chamber.

In an embodiment which is not shown, a restoring spring, which returns the nasal applicator 4 and the finger support 10 to an upper starting position analogous to that shown in FIG. 1 or holds them in this starting position, is supported, in a manner not illustrated in detail, outside the base region 3 in a cavity 18 of the closure part 2. This restoring spring is supported at the top against the finger support 10.

In the embodiment illustrated, this function of a restoring spring is performed by the spring accumulator 17, which therefore has a dual function.

Flow paths 26 to the metering opening 8 are formed above the upper sealing collar 13. The flow paths run upward to the outlet valve 7 between an outer contour of the guide part 6 and an inner wall of the nasal applicator 4.

To allow pressure compensation in the medium reservoir (not shown) after medium has been discharged, firstly there is a vent opening provided with the filter 22 in the base region 3. Secondly, a venting valve, which functions in the manner of a flexible tube valve, is formed between an outer annular shoulder of the inlet connection piece and an annular sealing lip extension of the sealing ring 19. The sealing lip extension 20 has an inner contour which tapers conically—from the top downward in the axial direction—and in the load-free starting position bears against the annular shoulder 21 of the inlet connection piece. Further details are to be found in the drawings in accordance with FIGS. 1 to 3.

The pump device of the metering apparatus 1 therefore comprises firstly in particular the metering chamber between the lower sealing collar 15 and the upper sealing collar 13, the longitudinal grooves 16, the flow paths 26, the outlet valve 7, the inlet valve 25, the cylinder sleeve 9, the metering piston 23 and a buffer chamber formed below the metering piston 23.

The metering apparatus 1 functions in the following way:

After the closure part 2 has been screwed onto the medium reservoir, first of all what is known as priming takes place during initial operation of the metering apparatus 1. This priming involves a number of pump operations delivering medium into the flow paths of the metering apparatus 1 until the air which is present in the metering apparatus 1 has completely escaped within the flow paths. A pump stroke is produced by pressing the finger support 10 down, with the result that the entire nasal applicator 4, including the guide part 6 and the intermediate sleeve 5 are also moved downward in the axial direction. The return of the finger support 10 and of the other moving parts of the metering apparatus is effected by the spring accumulator 17. A plurality of pump strokes inevitably forces the air which is present in the metering apparatus to escape upward through the metering opening 8, and the metering chamber between the lower sealing collar 15 and the upper sealing collar 14 is filled.

As soon as the priming has ended, desired metering of medium can take place. In the present case, the medium provided is a pharmaceutical or cosmetic liquid. After the priming operation has ended, this liquid, in accordance with the illustration presented in FIG. 1 is present both in the metering chamber described and in the flow paths 26 leading to the metering opening 8, and also in the flow passages formed by the longitudinal grooves 16 and in a lower end edge region of the cylinder sleeve 9 in the vicinity of the ball valve 25.

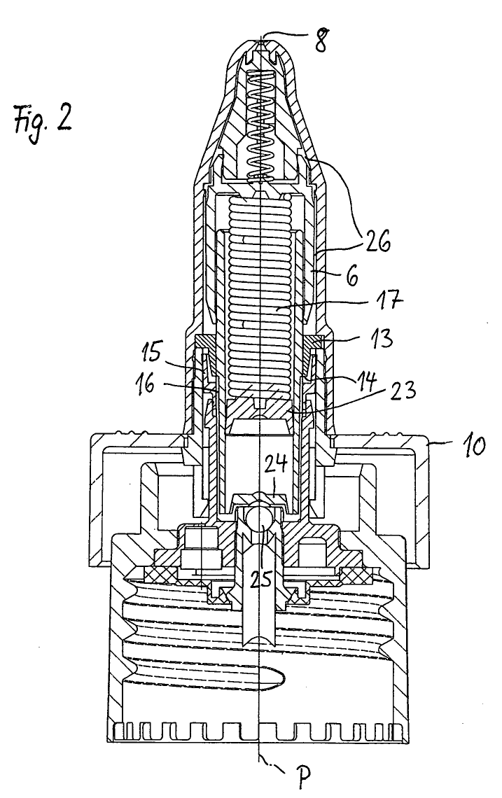

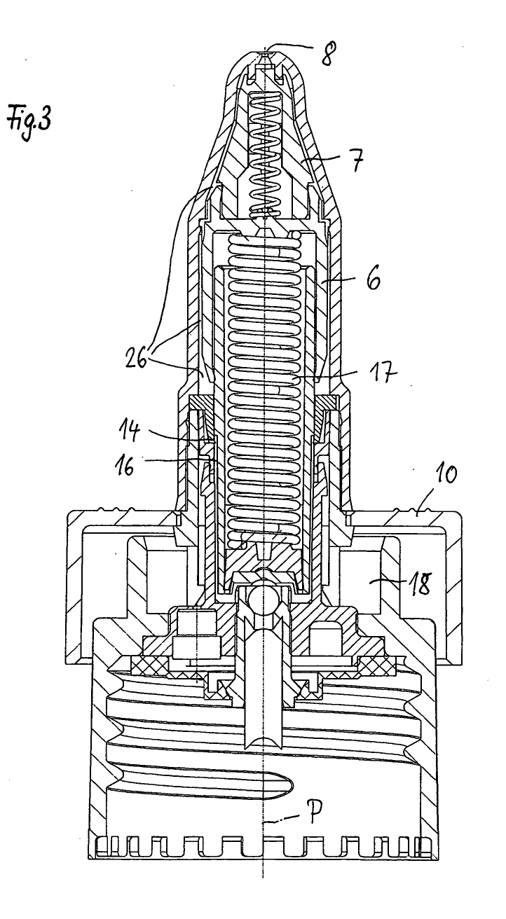

As soon as a compressive load in the downward direction is then exerted on the finger support 10, the metering chamber is compressed by the nasal applicator 4 including the upper sealing collar 13 being moved downward. The sealing collar 13 acts as a thrust piston. Since the liquid is incompressible, it escapes downward via the longitudinal grooves 16 and is pressed from below into a buffer chamber within the cylinder sleeve 9, which is delimited at the top by the metering piston 23 acting as a buffer piston. The spring force of the spring accumulator 17 is such that the spring accumulator 17, in the event of a corresponding actuating stroke on the part of the finger support 10, can yield upward, increasing the size of the buffer chamber. The stroke of the upper sealing collar 13 from the starting position shown in FIG. 1 to the region shown in FIG. 2, at which the sealing lip 14 of the upper sealing collar 13 comes into contact with an upper edge of the longitudinal grooves 16, serves as metering section. As soon as the sealing lip 14 has moved downward over the upper edge or the upper end edge of the longitudinal grooves 16, radial flow forces of the liquid starting from the longitudinal grooves 16 can act on the sealing lip 14, pressing the sealing lip 14 radially outward. This opens up the annular gap between the upper sealing collar 13 and the outer cylinder lateral surface of the cylinder sleeve 9 (FIG. 3), so that the liquid can escape upward into the flow passages 26. The sealing lip 14 moving over the upper end edges of the longitudinal grooves 16 therefore forms the trigger operation for the pre-stressed spring accumulator 17. As a result of the drop in pressure in the buffer chamber, the spring accumulator 17 can relax again, with the result that the metering piston 23 is pressed down into its lower starting position. The liquid which is present in the buffer chamber is delivered into the flow passages 26 via the longitudinal grooves 16 and the annular gap between cylinder sleeve 9 and sealing collar 13, with the result that the pressure of medium within the flow passages 26 is forcibly increased. The increased medium pressure causes the outlet valve 7 to open, so that a corresponding spraying operation in the outward direction can be effected through the metering opening 8 designed as a spray nozzle. The corresponding metering or spraying operation takes place exclusively as a result of the compression spring force of the spring accumulator 17, independently of the compressive force and acceleration or velocity of the actuating stroke of the operator. The metered volume is formed by the filled volume of the buffer chamber, which inevitably corresponds to the metered volume of the metering chamber. After the metering piston 23 has moved back into its lower starting position, emptying the buffer chamber, the discharge operation has ended. The outlet valve 7 closes as a result of the restoring force of its restoring spring. As soon as the operator removes the compressive load from the finger support 10, the spring accumulator 17 presses the finger support 10 and the nasal applicator 4 back into the starting position shown in FIG. 1, with the upper sealing collar 13 together with its sealing lip 14 also being moved back into the sealing state in the axial direction.

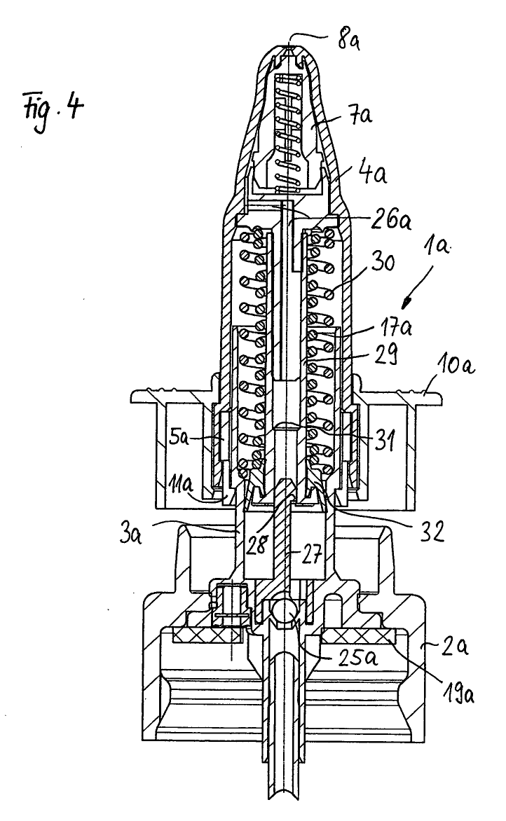

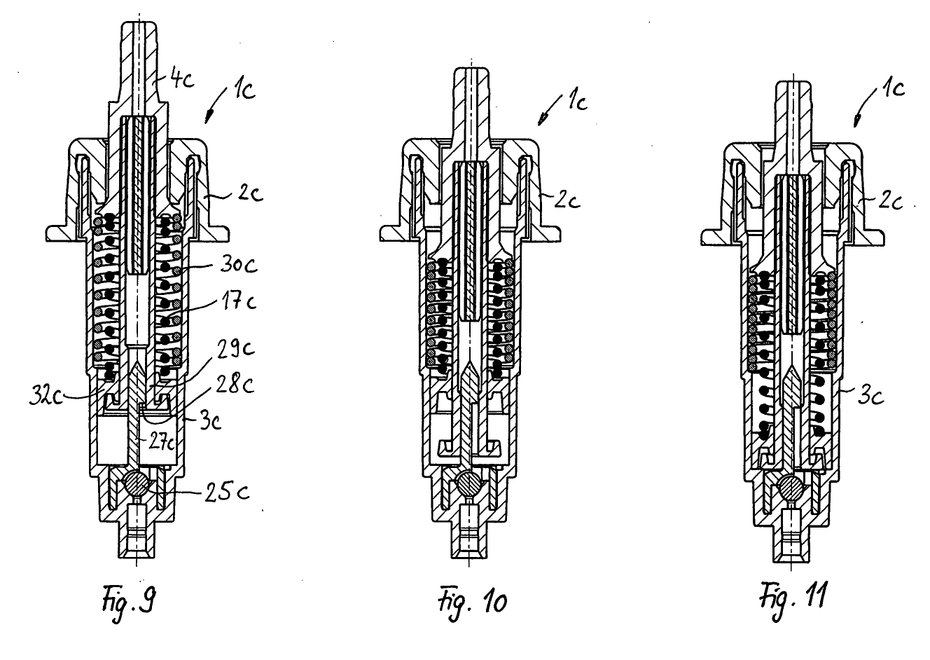

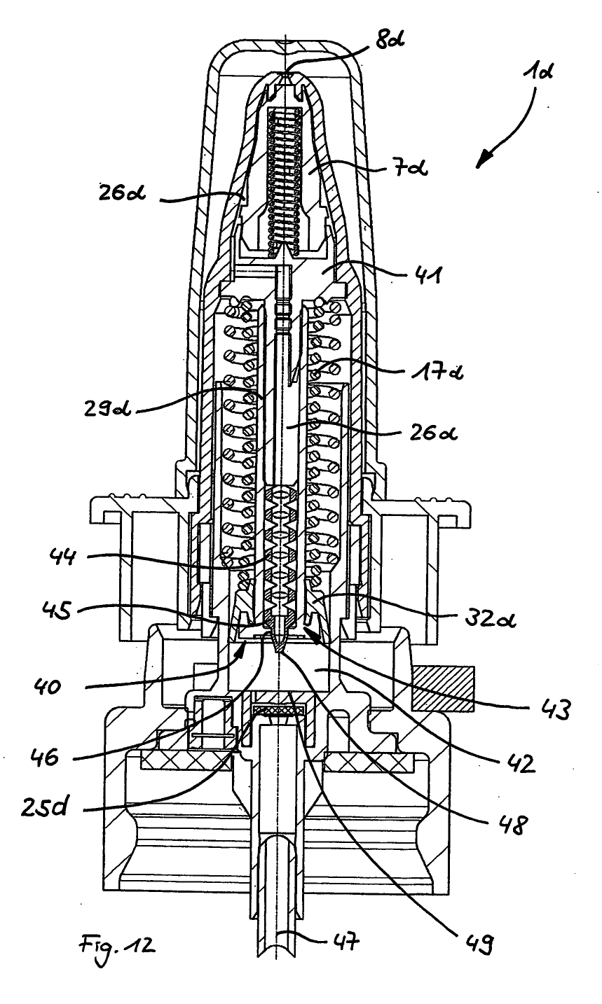

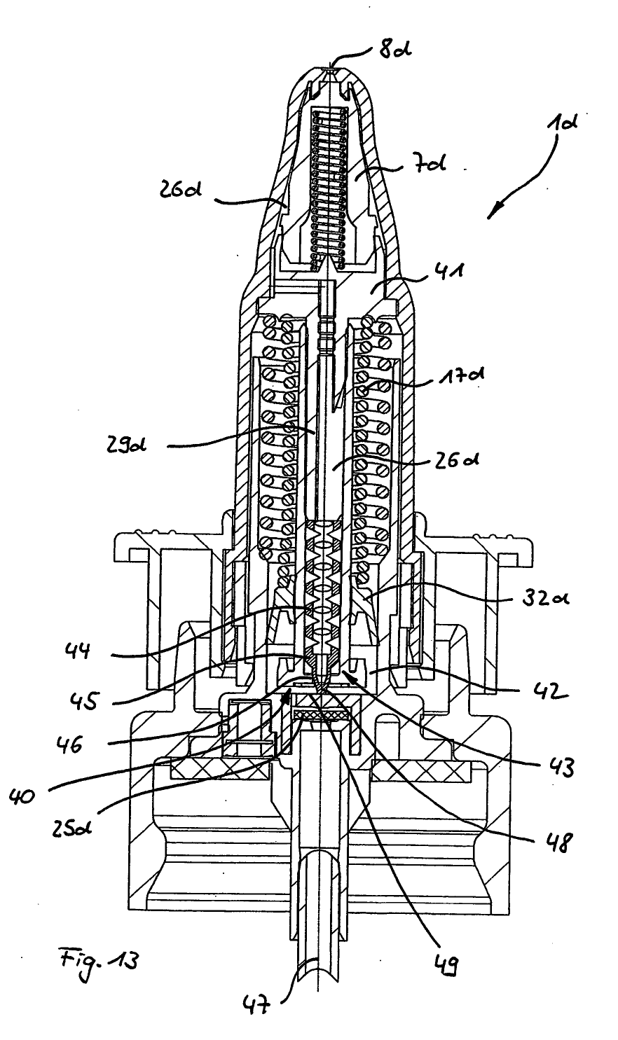

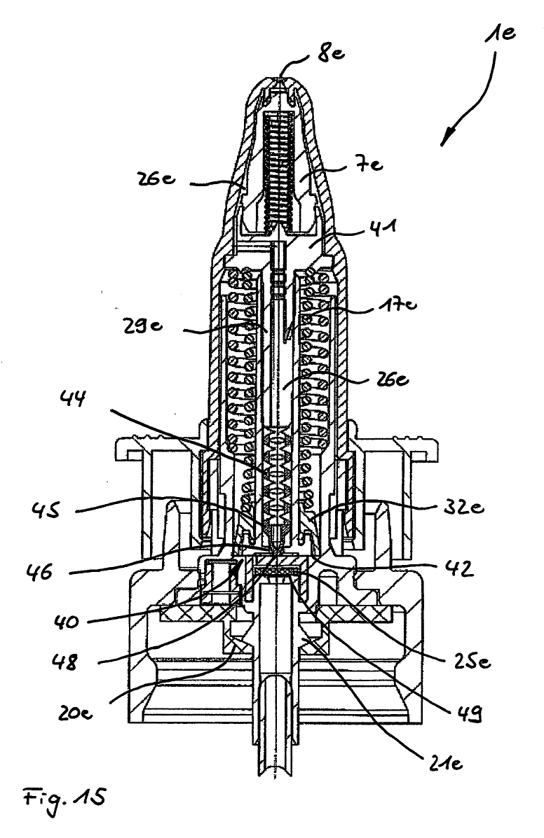

In the embodiment shown in FIGS. 4 to 6—as in the embodiment shown in FIGS. 1 to 3—a user-independent metering function is likewise achieved by a metering apparatus 1a. Unlike in the embodiment illustrated in FIGS. 1 to 3, in the embodiments described below in connection with FIGS. 4 to 14, an outlet valve is provided in the metering chamber. In the metering apparatus 1a, 1b and 1c, the outlet valve has a metering pin which is provided in a fixed position in the metering chamber, whereas in the metering apparatus shown in FIGS. 12 to 14 a spring-preloaded valve body is provided in a medium passage of a pump plunger.

The metering apparatus 1a has a closure part 2a which, in a manner not illustrated in more detail, can be secured to a medium reservoir. A base region 3a is secured to the medium reservoir in a positively locking manner by the closure part 2a. The base region 3a has a venting opening for the medium reservoir, which is acted on by a filter (not shown in more detail). Below the base region there is arranged a sealing ring 19a, which is recessed in the region of the venting filter, in such a manner as to allow permanent venting of the medium reservoir.

A lower portion of the base region 3a facing the medium reservoir is provided with a suction connection piece, into which a flexible suction tube is fitted from below. The suction connection piece includes a non-return valve in the form of a ball valve 25a, which is secured at the top by a caged section of a metering pin 27 which has the function of a control pin for the metering control.

The base region 3a has a cylinder section which projects upward coaxially with respect to the pump axis. The metering pin 27 is arranged in a fixed position within the base region 3a and projects upward coaxially with respect to the pump axis. The metering pin 27 is of rotationally symmetrical design only in its upper end region. Adjoining the end region in the downward direction, it is eccentrically recessed to form a metering edge 28.

A nasal applicator 4a together with a guide sleeve 5a and the finger support 10a are guided such that they can move in the axial direction relative to the cylinder section of the base region 3a. An axial stroke of the finger support 10a and of the nasal applicator 4a relative to the cylinder section of the base region 3a is limited by latching profiles on guide webs 11a and corresponding guide grooves on the cylinder section of the base region 3a. The nasal applicator 4a has an inner part 29 which is arranged in a fixed position in the nasal applicator 4a, is of hollow-cylindrical design in a lower region and serves as an axial guide for an outlet valve 7a in an upper region. As in the embodiment shown in FIGS. 1 to 3, the outlet valve 7a is provided with an integrated restoring spring. The metering opening 8a is likewise designed as a spray nozzle in accordance with the embodiment shown in FIGS. 1 to 3. The metering apparatus 1a-like the metering apparatus 1 shown in FIGS. 1 to 3—is used to discharge a liquid medium in the form of a pharmaceutical or cosmetic liquid. Flow passages 26a are formed in the inner part 29 in order to enable the liquid which is to be discharged to be passed through the interior of the inner part 29 to the outlet valve 7a. The profile of the flow paths 26a and the configuration of the hollow chamber can be seen from FIGS. 4 to 6. It can also be seen from FIGS. 4 to 6 that the inner part 29 is not of single-part design, but rather comprises a hollow-cylindrical lower region and an upper guide and support region, which are fixedly connected to one another, in particular by press-fitting. Details of this can be found in the drawings presented in FIGS. 4 to 6.

A sealing collar 32 is guided in a longitudinally displaceable manner on the outer lateral surface of the hollow cylinder section of the inner part 29; this sealing collar 32 is sealed off on the inner side by the hollow-cylindrical section of the inner part 29. On the outer side, the sealing collar 32 is fitted in a circumferentially sealed manner to the inner wall of the cylinder section of the base region 3a. As is described in more detail below, the sealing collar 32 serves as a metering piston for discharging the liquid medium from the metering opening 8a. The sealing collar 32 is pressed downward by a spring accumulator 17a, the spring accumulator 17a being designed as a coil spring which coaxially surrounds the hollow-cylindrical section of the inner part 29. The spring accumulator 17a is supported at the top against the inner part 29.

A further compression coil spring 30, which is fitted coaxially over the spring accumulator 17a in accordance with the illustration presented in FIGS. 4 to 6, is arranged coaxially outside the spring accumulator 17a. The compression coil spring 30 serves as a restoring spring for the nasal applicator 4a and the finger support 10a and is supported at the top against the inner part 29 and at the bottom against an annular shoulder of the base region 3a (cf. FIGS. 4 to 6).

In the assembled starting position of the metering apparatus 1a, the metering pin 28 projects into the hollow chamber of the hollow-cylindrical section of the inner part 29 from below. As seen in the axial direction, the hollow chamber is provided with two cylinder sections of different diameters. A lower, smaller cylinder section merges into an upper, larger cylinder section in the region of a step shoulder 31. The upper end region of the metering pin 27 forms a piston section which ends tightly with the lower cylinder section of the hollow chamber of the inner part 29.

The metering apparatus 1a illustrated in FIGS. 4 to 6 functions in the following way:

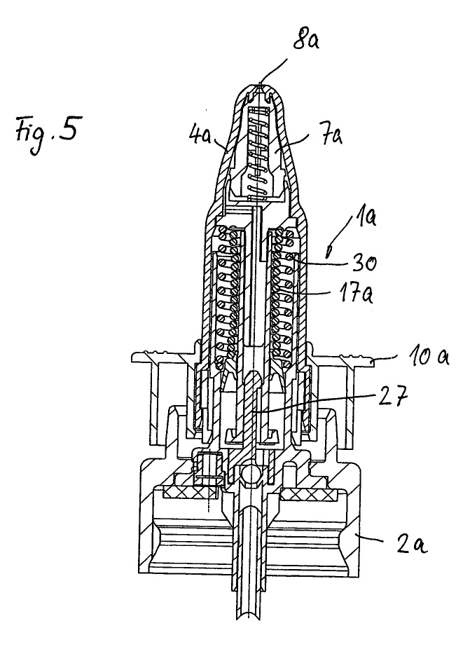

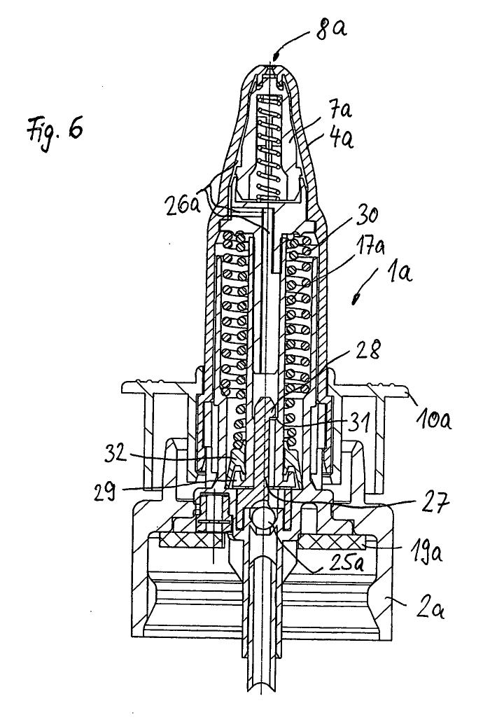

In the embodiment shown in FIGS. 4 to 6 too, firstly priming has to take place after first operation, analogously to the embodiment shown in FIGS. 1 to 3, in order to allow air to escape from the flow paths of the metering apparatus and liquid medium to be delivered into them in one or more pump strokes. As soon as the priming operation has ended, all the flow paths within the metering apparatus 1a have been filled with liquid medium. If, in the starting position shown in FIG. 4, an operator, by applying a compressive force, moves the finger support 10a and the nasal applicator 4a downward relative to the closure part 2a, the hollow-cylindrical section of the inner part 29 inevitably likewise moves downward relative to the fixed metering pin 27. On account of the medium pressure which is already present in the metering chamber below the sealing collar 32, the sealing collar 32 remains in its starting position shown in FIGS. 4 and 5 until the metering edge 28 moves over the step shoulder 31 within the hollow chamber of the inner part 29 (approximately corresponding to the position shown in FIG. 5). As soon as the metering edge 28 has moved over the step shoulder 31, liquid medium can escape out of the metering chamber into the hollow chamber and upward to the flow paths 26a, with the result that the liquid medium which is already present in these flow paths 26a and in the region of the outlet valve 7a must inevitably be displaced. This can only take place by the outlet valve 7a being pressed downward counter to the spring force of its restoring spring, with the result that it opens and the liquid medium can escape into the environment via the metering opening 8a designed as a spray nozzle. Discharge of medium takes place exclusively as a result of the compressive spring force of the spring accumulator 17a, since opening of the flow path in the region of the metering edge 28 and of the step shoulder 31 causes the medium pressure in the metering chamber to drop, and accordingly the spring force of the spring accumulator 17a can press the sealing collar 32 downward as far as the limit position shown in FIG. 6. The pre-stressed spring accumulator relaxes as a result. The discharge operation is ended by the sealing collar 32 coming to a stop against the bottom region of the metering chamber. It is not possible for the liquid to escape into the medium reservoir, since the ball valve 25a prevents the liquid from flowing back into the medium reservoir. The same also applies to the embodiment shown in FIGS. 1 to 3.

As soon as the operator then removes the pressure from the finger support 10a, the restoring spring 30 can return the nasal applicator 4a, including the finger support 10a, upward to their starting position. The inner part 29 is inevitably also moved upward at the same time. A lower end edge region of the inner part 29 is provided with an integrally formed driver disk, which is not indicated in more detail and engages in an axially and/or radially positively locking manner with the sealing collar 32, moving the latter upward with it counter to the compressive force of the spring accumulator 17a. The pulling-back of the sealing collar 32 produces a reduced pressure in the metering chamber, the volume of which is inevitably increased again, which causes the ball valve 25a to open and liquid to be topped up from the medium reservoir. As soon as the nasal applicator 4a and the finger support 10a have reached their upper limit position, delimited by latching profiles of the guide webs 11a, the starting position of the metering apparatus 1a illustrated in FIG. 4 has been reached again.

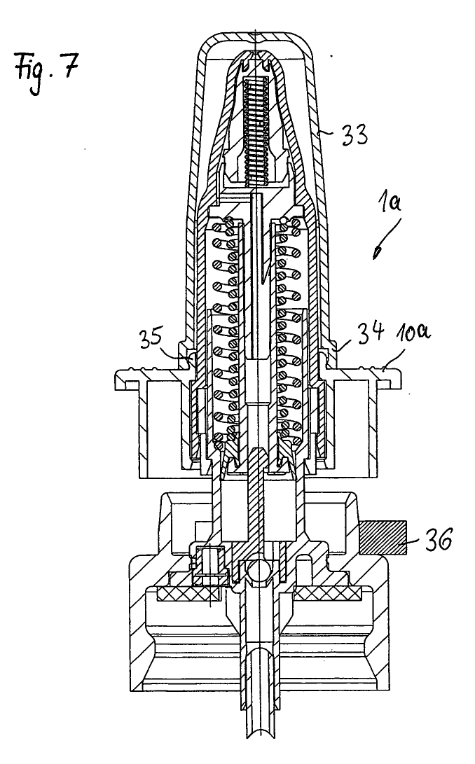

FIG. 7 shows the metering apparatus 1a illustrated in FIGS. 4 to 6 in an at-rest position in which it has not yet started to operate but has already been assembled such that it is fully ready for operation. Here, a protective cap 33, which is releasably latched onto an encircling latching shoulder 35 of the finger support 10a by means of a latching edge 34, has been fitted onto the nasal applicator. The closure part is assigned an actuation block 36, which blocks an axial stroke of the finger support 10a at least in an active region. Moreover, the actuation block 36 allows assembly of the snap-action housing 2a with the finger support 10a already fitted.

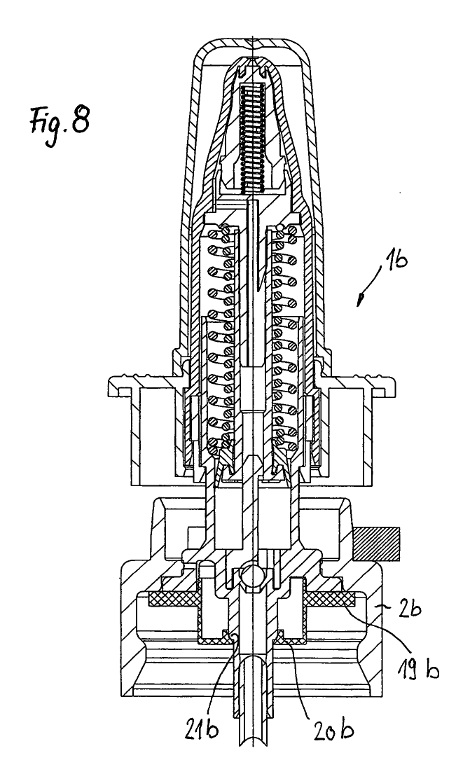

The metering apparatus 1b shown in FIG. 8 substantially corresponds to the metering apparatus 1a which has been described in extensive detail with reference to FIGS. 4 to 7. The only difference is that in this case a disk-like sealing ring 19b is provided in the region of the closure part; this sealing ring 19b, in accordance with the embodiment shown in FIGS. 1 to 3, is provided with an integrally formed sealing lip extension 20b. The sealing lip extension 20b, together with an annular shoulder 21b of the suction connection piece, forms a venting valve which functions in the style of a flexible tube valve. The more detailed design of the sealing lip extension 20b and of the annular shoulder 21b corresponds to the similar design of the metering apparatus 1 illustrated in FIGS. 1 to 3, and consequently for a more detailed explanation reference is made to the description given in connection with those figures. In the embodiment shown in FIG. 8, the annular shoulder 21b likewise forms a supporting edge which is of approximately right-angled design and against which an inner sealing surface of the conical inner contour of the sealing lip extension 20b bears at an acute angle. The sealing lip extension 20b is elastically resilient on the radially outer side and in the axially downward direction, and in the load-free starting position returns to the sealing closure position shown in FIG. 8. The axial end face of the annular shoulder 21b reacts very sensitively to pressure differences, and consequently opens very easily.

The metering apparatus 1c illustrated in FIGS. 9 to 11, in terms of its functional structure, substantially corresponds to the embodiment shown in FIGS. 4 to 6. The main difference is that in this case the entire pump device projects downward from the closure part 2c and therefore projects into a corresponding medium reservoir. To provide a better understanding, functionally equivalent parts of the metering apparatus 1c are provided with the same reference designations as in the embodiment shown in FIGS. 4 to 7, but with the addition of the letter c. The metering apparatus 1c is not intended exclusively for nasal application, but rather can also be used for applications of other configurations. Moreover, the metering apparatus 1c is provided in particular for discharging media which are not liquid but do flow freely, such as gels, foams, suspensions or the Like. The component which is denoted by reference designation 4c accordingly does not necessarily constitute an applicator with a corresponding metering opening, but rather may form an intermediate part onto which a suitable applicator for the application desired in each instance is fitted. In this case, the base region 3c forms the housing of the pump device and in the assembled state, it is immersed in the medium reservoir. The method of operation corresponds to that of the embodiment shown in FIGS. 4 to 6, and consequently reference can be made to the disclosure of the functioning of the metering apparatus 1a. In the metering apparatus 1c shown in FIGS. 9 to 11, likewise, the spring accumulator 17c and the restoring spring 30c for the pump device are fitted coaxially over one another. The moving pump part is the component 4c, which is placed under pressure in a suitable way from above, preferably by an applicator head (not shown), allowing the method of operation which has already been described.

The metering apparatus 1d illustrated in FIGS. 12 to 14 substantially corresponds to the metering apparatus 1a which has been extensively described with reference to FIGS. 4 to 7. Unlike in the metering apparatus described in connection with FIGS. 4 to 7, in the metering apparatus 1d illustrated in FIGS. 12 to 14, there is a pump plunger 40 provided with an outlet valve 43. The pump plunger 40 is composed of a filling piece 41 and the hollow-cylindrical inner part 29d fitted onto a sleeve-like section of the filling piece 41, and has a medium passage, designed as a flow passage 26d, for discharging the medium from the metering chamber 42. The filling piece 41 is accommodated in the nasal applicator 4d and serves as an abutment for the outlet valve 7d. While the outlet valve 7d at least temporarily disconnects the medium passage from the metering opening 8d, the outlet valve 43, which is designed as a trigger device for the spring accumulator 17, is provided at an end region of the pump plunger 40 which faces the metering chamber 42. The outlet valve 43, which is designed as a single-piece arrangement of a plastic compression spring section 44 and a valve body 45, forms a temporarily closable valve opening with a valve seat 46 provided in the pump plunger 40. For actuation of the outlet valve 43, the valve body 45 projects, by way of a projection 48, beyond an end face of the pump plunger 40 into the metering chamber 42.

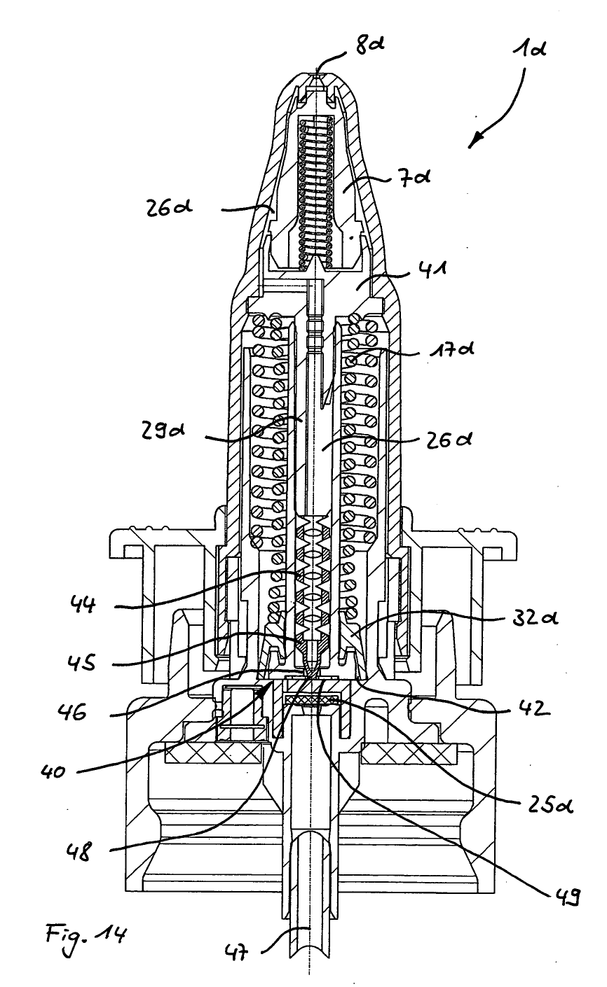

As illustrated in FIGS. 12 and 13, the outlet valve 43 is pressed into the valve seat 46 by the plastic compression spring section 44, which is supported against the sleeve-like extension of the filling piece 41, and therefore reliably closes the medium passage even in the event of a rise in a pressure on the medium in the metering chamber 42. Since, however, with increasing actuating force, the pump plunger is moved onto the medium reservoir (not shown) in the direction of a longitudinal center axis 47 of the pump device, the projection 48 of the valve body 45 projecting into the metering chamber 42 can come into contact with a bottom section 49 of the metering chamber. Further approach of the pump plunger 40 to the bottom section 49 of the metering chamber 42 causes the valve body 45 to be displaced back counter to the closure force of the plastic compression spring section 44. As a result, an annular valve gap is formed between the valve seat 46 and the valve body 45, allowing the medium to flow out of the metering chamber 42 in the direction of the flow passages 26d.

Only as a result of the valve body 45 being displaced back out of the valve seat 46 is the actuation energy which has been stored in the spring accumulator 17d as a result of elastic deformation of the spring turns released, so that the sealing collar 32d can be displaced along the sliding guide, formed by the inner part 29d, in the direction of the bottom section 49, and as a result the medium enclosed in the metering chamber 42 is pressed into the flow passages 26d.

The plastic compression spring section 44 is designed as a substantially cylindrical sleeve and has slots which are introduced orthogonally with respect to the longitudinal center axis 47, ensure flexibility in the direction of the longitudinal center axis 47 and therefore allow a spring action. Since the outlet valve 43 formed from the plastic compression spring section 44 and the valve body 45 is located directly in the medium passage, a single-piece design formed from a plastics material is advantageous, since suitable plastics materials are inert with respect to the medium and do not bring about any undesirable change in the medium.

In the metering apparatus shown in FIGS. 12 to 14, the inlet valve 25d provided is a diaphragm valve which is produced by a flexible plate and, when an excess pressure is built up during a compression phase of the spring device 17d, closes off a medium passage connected to the medium reservoir (not shown).

The metering apparatus 1e illustrated in FIG. 15 corresponds to the embodiment shown in FIGS. 12 to 14, except that venting of the medium reservoir is realized by means of an annular lip seal. To gain an understanding of the annular lip seal, reference should be made to the description given in connection with FIG. 8.

In an embodiment of the invention which is not illustrated, the valve body is formed separately from the plastic compression spring section, with the plastic compression spring section being designed as a coil spring, with the result that an altered valve characteristic can be realized.

1. Metering apparatus for media having an applicator, which has at least one metering opening, having a pump device, which has pump parts which can move in the axial direction relative to one another in order to deliver medium out of a medium reservoir to the metering opening, having a metering chamber, having an inlet valve, having a manually operable actuating device, which is operatively connected to the pump device in order to achieve a pump stroke, and having a spring accumulator, which can be pre-stressed by movement of the actuating device and can be released by a triggering unit as a function of an actuating stroke of the actuating device in order to enable a metering stroke of the pump device to be carried out, wherein the pump device comprises a buffer chamber which, in the event of an actuating stroke, receives a metered volume from the metering chamber and out of which the metered volume is discharged to the metering opening during a metering stroke.

2. Metering apparatus according to claim 1, wherein the volume of the buffer chamber can be changed by a metering piston, to which the spring accumulator is operatively connected.

3. Metering apparatus according to claim 1, wherein the metering chamber is configured as an annular chamber of variable volume which coaxially surrounds the buffer chamber.

4. Metering apparatus according to the preamble of claim 1, wherein the spring accumulator is arranged axially between the metering opening and a medium reservoir.

5. Metering apparatus according to the preamble of claim 1, in which the actuating device and/or the pump device is assigned a restoring spring arrangement for returning the pump parts into a starting position, wherein the spring accumulator and the restoring spring arrangement, at least in sections, are arranged such that they are fitted coaxially over one another.

6. Metering apparatus according to claim 1, wherein a housing part of the metering apparatus which can be connected to the medium reservoir is assigned a venting device for the medium reservoir.

7. Metering apparatus according to claim 5, wherein the spring accumulator and the restoring spring arrangement are formed by a common coil spring.

8. Metering apparatus according to claim 7, wherein the common coil spring also comprises a spring function for closing an outlet valve in the region of the metering opening.

9. Metering apparatus according to claim 8, wherein all the spring elements, including spring accumulator, restoring spring arrangement and closing spring for the outlet valve, are arranged outside the flow path of the medium.

10. Metering apparatus for media having an applicator for discharging medium, having a pump device, which has pump parts which can move axially relative to one another in order to deliver medium out of a medium reservoir to a metering opening of the applicator, and having a venting device assigned to the medium reservoir, wherein the venting device comprises a venting valve in the form of an annular lip seal, which annularly surrounds the outer side of a suction connection piece projecting into the medium reservoir.

11. Metering apparatus according to claim 10, wherein the suction connection piece has an annular shoulder which forms a valve seat, and in that the annular lip seal has a sealing collar, which protrudes in particular radially with respect to the pump axis and on the inner side comprises a conically tapered sealing surface.

12. Metering apparatus according to claim 11, wherein the annular shoulder forms a right-angled step shoulder, against the peripheral edge of which the conically tapered sealing surface of the sealing collar bears at an acute angle.

13. Metering apparatus for media having an applicator, which has at least one metering opening, having a pump device, which has pump parts which can move in the axial direction relative to one another in order to deliver medium out of a medium reservoir to the metering opening, having a metering chamber, having an inlet valve, having a manually operable actuating device which is operatively connected to the pump device in order to achieve a pump stroke, and having a spring accumulator, which can be pre-stressed by movement of the actuating device and can be released by a triggering unit as a function of an actuating stroke of the actuating device in order to enable a metering stroke of the pump device to be carried out, wherein the triggering unit is designed as an outlet valve which is provided for temporarily closing a medium passage, which is assigned to the metering chamber and is connected to the metering opening, at the pump device.

14. Metering apparatus according to claim 13, wherein the outlet valve is formed from a metering pin assigned to the metering chamber and a pump plunger which can move relative to the metering pin.

15. Metering apparatus according to claim 13, wherein a venting device is provided, which comprises a venting valve in the form of an annular lip seal, which annularly surrounds the outer side of a suction connection piece projecting into the medium reservoir.

16. Metering apparatus according to claim 13, wherein the outlet valve has a valve body and a spring device which is assigned to the valve body and is designed to apply a valve-closing force.

17. Metering apparatus according to claim 16, wherein the spring device is designed as a compression spring, preferably as a plastic compression spring, in particular as a plastic compression spring formed integrally with the valve body.

18. Metering apparatus according to claim 16, wherein at the end side the medium passage opens out from a pump plunger assigned to the pump device into the metering chamber, and the valve body is accommodated in the pump plunger for the purpose of closing the end-side opening of the medium passage.

19. Metering apparatus according to claim 18, wherein the valve body has a projection which, in an at-rest position of the outlet valve, projects beyond an end-side of the pump plunger facing the metering chamber into the metering chamber and is provided for operative connection to a wall section, lying opposite the end-side of the pump plunger, of the metering chamber.

20. Metering apparatus according to claim 13, wherein an inlet valve assigned to the metering chamber is designed as a diaphragm valve for closing a medium passage connected to the medium reservoir.
